(19) United States
(12) Patent Application Publication
(10) Pub. No.: US 2006/0096808 A1
(43) Pub. Date: May 11, 2006

(54) Universal oil change and filter relocation systems

(76) Inventor: Amir Rosenbaum, Los Altos Hills, CA (US)

Correspondence Address: THE HECKER LAW GROUP, 1925 CENTURY PARK EAST, SUITE 2300, LOS ANGELES, CA, 90067, US

(21) Appl. No.: 10/984,555

(22) Filed: Nov. 8, 2004

(51) Int. Cl. F16N 33/00

(52) U.S. Cl. 184/1.5

(57) ABSTRACT

Aspects of the invention include a universal oil change system and an oil filter relocation system. The oil change system changes the location at which oil is drained from a vehicle engine, such as from the bottom of the engine block to a more convenient and accessible location on the engine compartment. The system includes a drain tube for routing oil from an oil pan and, optionally a pump, which may be operable from the cigarette lighter of the automobile for extracting the used engine oil. Furthermore, an oil filter relocation system which facilitates relocation of an oil filter, such as from an inaccessible point on the engine to an accessible area in the engine compartment is provided.

### FIELD OF THE INVENTION

This invention relates to the field of automotive maintenance. More specifically the invention relates to a universal quick oil change kit and a filter relocation system.

### BACKGROUND

In automobile engines, mechanical components such as pistons move and rub against other mechanical components, sometimes at very high speeds. This rubbing, without lubrication to reduce friction, may generate very high heat and severe component wear, resulting in eventual engine failure.

Engine oil is generally used as a lubricant to facilitate engine operation by reducing friction and consequently wear and heat. However, even with the lubrication provided by the engine oil, friction is never reduced to zero thus heat will still be generated and wear will still occur. Therefore, excessive heat may still occur after prolonged operation at high speeds due to rubbing of mechanical components and engine components wear whenever the engine is in operation.

Although, this excessive heat is usually dissipated by other means, engine oil, like most other liquids, will break down at a certain temperature. Moreover, dirt due to shavings from the rubbing of mechanical components during cycling of the engine, for instance, or water from condensation, may accumulate over time in the engine oil thus reducing its effectiveness. Thus, periodic replacement of engine oil is necessary to keep the engine healthy, i.e., prevent excessive wear and tear.

There are two basic categories of engine oil used today: synthetic and non-synthetic types. Synthetic engine oils represent recent technological advances to the engine oil market. Synthetic oils seem to provide better lubricating characteristics than that of the non-synthetic genre thus requiring less frequent replacement than the non-synthetic type oils. In fact, the life span of most synthetic type oil may last as long as five times that of the non-synthetic genre, and may be five times as expensive.

Traditionally, the non-synthetic engine oil is a byproduct of petroleum processing. These oils seem to break down in characteristics after about three to five thousand miles thus requiring more frequent engine oil replacement.

Thus, the frequency of oil change may depend largely on the type of engine oil used in lubricating an automobile engine. However, regardless of the type of oil used, the oil in an automobile engine may need to be changed usually based on recommendations of the automobile manufacturer.

Each automobile has a means by which an operator may remove and replace the engine oil when necessary. For instance, each automobile engine has a drainage plug, usually at the lowest point of the engine block, which may be removed to extract used oil. Then new oil may be poured into the engine through an oil filler access opening, which is usually on or near the top of the engine block. Of course, new oil is only added after the drain plug has been replaced.

Some operators perform their own automobile engine oil change to save money. Sometimes it is because of convenience. Sometimes it is for fun. But for whatever reason, the operator is generally required to jack-up the automobile, crawl underneath the engine, remove the drain plug with a proper wrench, and drain the used engine oil into a drain pan. In addition, the operator may want to replace the oil filter at each oil change.

Recently, with the proliferation of quick oil change stations and their relatively inexpensive rates, most operators have forgone the do-it-yourself mode and opted for the convenience of the quick oil change stations. Moreover, the quick oil change stations have freed the operator from worries about the potential hazard to clothing and body inherent in crawling under a potentially leaky engine.

In addition, because of lack of space around the engine block, some manufacturers locate the oil filter in such places that it may require special instruments to remove and replace the oil filter thus another reason for the convenience of the quick change stations.

However, even with the relatively inexpensive rates of the quick change stations, the price for an oil change may still be approximately four times the price of the oil and filter combined. Thus, a quick change system for do-it-yourselfers that eliminates the hazards inherent with the location of the oil drain plug, and sometimes the oil filter, is desirable.

### SUMMARY OF THE INVENTION

The present invention is directed to a universal quick oil change system. The oil drain plug of an automobile engine is usually located at the lowest point of the engine block, which is usually at the bottom of the oil pan. Thus, the inconvenience of crawling under the engine to remove used engine oil and the proliferation of relatively cheap quick oil change stations have resulted in most do-it-yourselfer's foregoing the hassle of changing their own engine oil.

The present invention provides the incentive and means for any consumer to quickly and cheaply change their own engine oil. An embodiment of the present invention provides a system for relocating the drain plug from the bottom of the engine block to any convenient location in the engine compartment as the consumer desires. A pump, which may be electric, may be provided to quickly and cleanly extract the used oil at oil change time eliminating the necessity of going to one of those quick oil change stations. Thus, with the present invention, oil change will be mostly the cost of buying the replacement oil and filter.

In another embodiment, an oil filter relocation system is also provided. The oil filter relocation system may be installed in those automobiles with a not-so-easy to reach oil filter location. Even if the vehicle has an easy-to-reach oil filter location, spillage is involved and this problem is addressed by the kit. The kit has a quick disconnect and re-connect of the oil filter adapter bracket that allows the oil filter to be held at such an angle as to drain it completely before removal, eliminating spillage.

### BRIEF DESCRIPTION OF THE DRAWINGS

FIG. 1 is an illustration of the components of the drain plug relocation system in accordance with an embodiment of the present invention.

FIG. 2A is an illustration of banjo bolt 170 in accordance with an embodiment of the present invention.

FIG. 2B is an illustration of the process of coupling drain tube 110 to the drain hole 260 of engine block 240.

FIG. 2C is an illustration of the result of coupling banjo bolt 170 with drain tube 110.

FIG. 3 is an illustration of installation of drain tube mount bracket 130.

FIG. 4 is an illustration of mounting drain tube 110 on the mounting bracket.

FIG. 5 is an illustration of engine oil change procedure in accordance with an embodiment of the present invention.

FIG. 6 is an illustration of the components of a quick change oil filter relocation system in accordance with an embodiment of the present invention.

FIG. 7 is an illustration of selection of filter sleeve for an automobile installation.

FIG. 8A is an illustration of installation of the lower filter sleeve into the lower filter adapter.

FIG. 8B is an illustration of installation of the upper filter sleeve into the upper filter adapter.

FIG. 9 is an illustration of installation of the lower filter adapter.

FIG. 10 is an illustration of installation of the filter relocation tubes.

FIG. 11 is an illustration of installation of the upper filter adapter and filter.

FIGS. 12A and 12B are illustrations of one embodiment of mounting the upper filter adapter in the engine compartment.

FIGS. 13A and 13B are illustrations of another embodiment of mounting the upper filter adapter in the engine compartment.

FIGS. 14A, 14B, and 14C are illustrations of another embodiment of mounting the upper filter adapter in the engine compartment.

FIG. 15 is an illustration of the prior art locations of the oil drain plug and oil filter in an automobile.

FIG. 16 is an illustration of the configuration of the oil drain and filter systems after installation of an embodiment of the present invention.

### DETAILED DESCRIPTION

The invention discloses a universal quick oil change system for an automobile. In the following description, numerous specific details are set forth to provide a more thorough description of embodiments of the invention. It will be apparent, however, to one skilled in the art that the invention may be practiced without these specific details. In other instances, well known features have not been described in detail so as not to obscure the invention.

In one embodiment, the present invention comprises a system for relocating the drain plug of an engine from the bottom of the engine block to a convenient location in the engine compartment. In another embodiment, a system for relocating the oil filter to a more convenient location in the engine compartment is also provided.

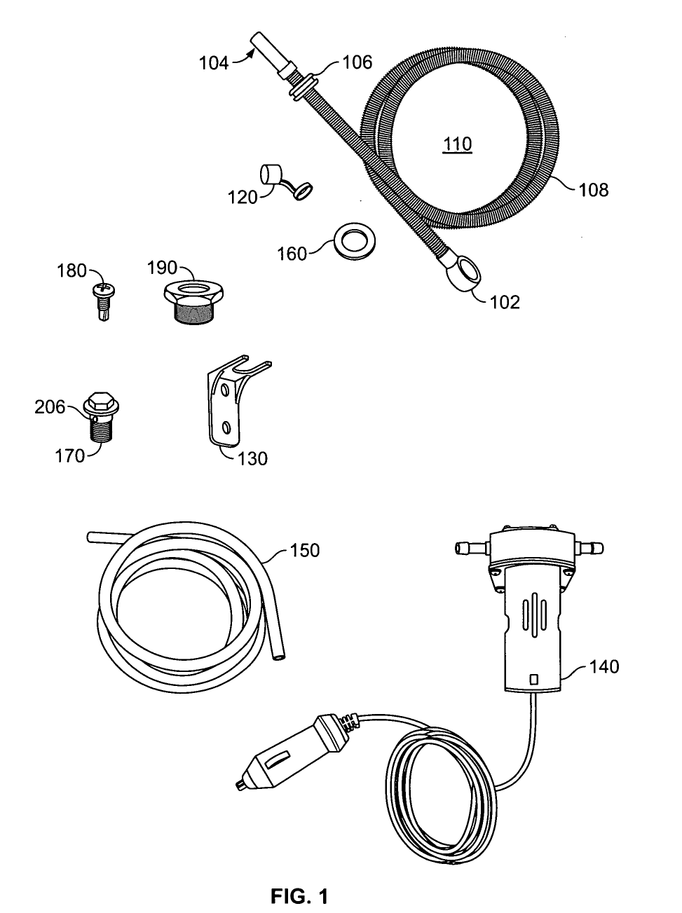

The invention will now be described in detail in conjunction with the Figures. FIG. 1 is an illustration of the components of the drain plug relocation system in accordance with an embodiment of the present invention. As illustrated, in a preferred embodiment, the drain plug relocation system comprises an oil drain tube 110; oil drain cap 120; oil drain tube mount bracket 130; pump 140; hose and/or tubing 150; washer 160; banjo bolt 170; self tapping screw 180; and drain plug adapter 190.

Oil drain tube 110 comprises banjo head 102 at one end, a sleeve 106 and adapter 104 at the other end. The remainder of the oil drain tube may be made of appropriate material. The hose and/or tubing material could be flexible metallic or reinforced rubber, nylon, etc., since it may need to be routed through available space from the bottom of the engine to the top. For instance, the type of material generally used for the gas line of a gas dryer may be used for the body of oil drain tube 110.

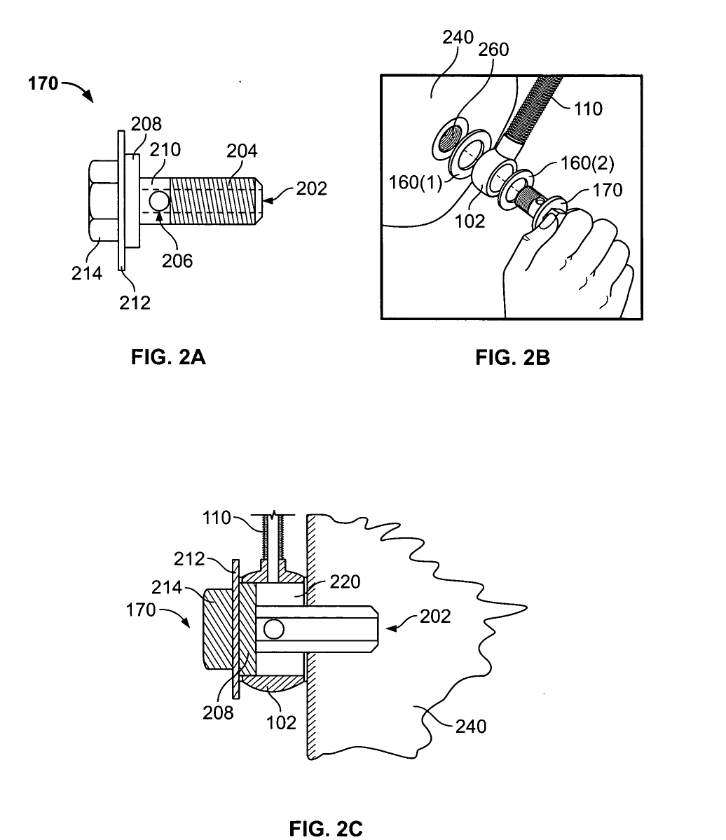

Banjo bolt 170 is further illustrated in FIG. 2A. As illustrated, banjo bolt 170 comprises a head 214, which may be a hex head, a square head, or other type head suitable for securing the bolt to a threaded surface. Head 214 is attached to one side of shoulder 212, which is essentially a flat plate. Attached on the other side of shoulder 212 is elbow section 208. Elbow section 208 is configured to fit snugly into banjo section 102 (see FIG. 2C) of drain tube 110. Thus, elbow section 208 is configured with the same shape as the inside of banjo section 102 of the drain tube. For instance, in the illustration of FIG. 1, section 102 of drain tube 110 is circular thus elbow section 108 is a round, thick, flat plate of approximately the same diameter as inside of banjo section 102.

On the other side of elbow section 208 is a bolt section comprising threaded section 204 and optionally non-threaded section 210. The non-threaded section 210 of the bolt may be located between the threaded section 204 and the elbow section 208. And along the length of the threaded section 204 is a tunnel 202 for directing fluid from the free end of the bolt section through one or more channels 206 located close to the fixed end of the bolt, i.e., near where the bolt section and elbow 208 are joined.

As Banjo bolt 170 is configured in an embodiment of the present invention, a chamber 220 is created when Banjo bolt 170 is coupled to banjo head 102. This is illustrated in FIG. 2C. As illustrated, fluid passes through tunnel 202 into tunnel 206 and then into chamber 220. Tunnels 202 and 206 form a “T” with tunnel 206 being the top of the “T”. Chamber 220 provides access for fluid to pass from the engine block to drain tube 110. Section 240 is a cutout section of the automobile engine block.

FIG. 2B is an illustration of the process of coupling drain tube 110 to the drain hole 260 of engine block 240. As illustrated, the banjo head 102 of drain tube 110 is placed between two washers, 160(1) and 160(2), and banjo bolt 170 may be threaded through the washers and banjo opening of banjo head 102 to couple with drain hole 260 of the engine block. The initial threading of banjo bolt 170 may be accomplished by hand. Thereafter, an appropriate wrench may be used to tighten banjo bolt 170 to specifications provided by the engine manufacturer for the drain plug.

In one or more embodiments, it may be necessary to use adapter 190 before installation of drain tube 110. Adapter 190 may be necessary if the drain hole 260 is two large for the diameter of the banjo bolt section 204, for example. In such a case, adapter 190 may be threaded into drain hole 260 using a washer 160. Thereafter, the inside hole of the adapter 190 becomes the new drain hole for installation of banjo bolt 170, as discussed above.

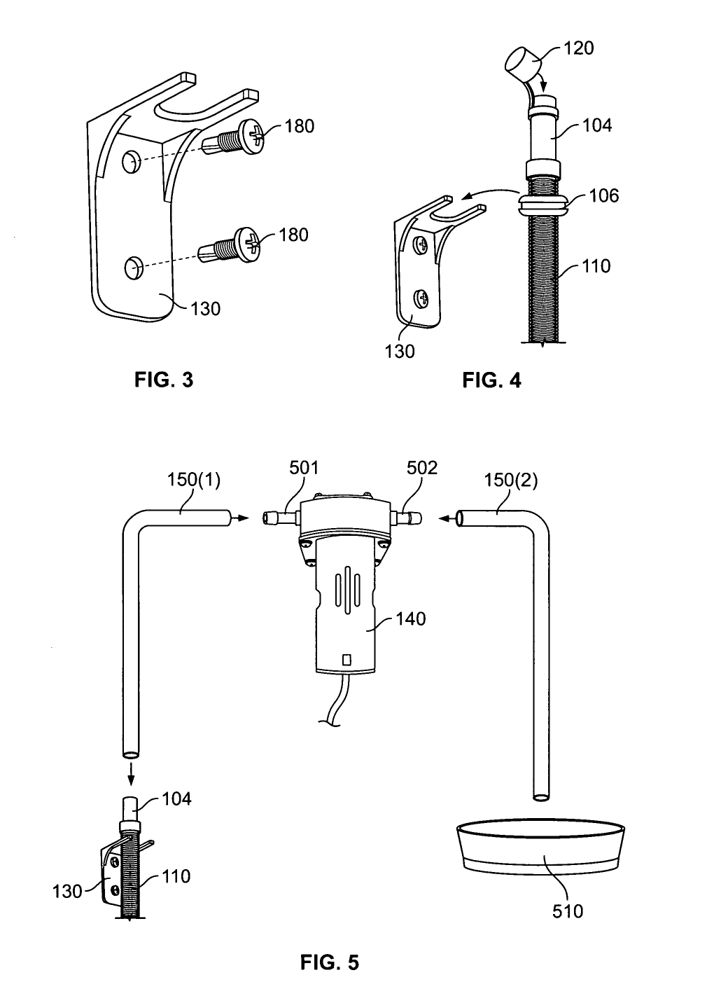

Subsequently, drain tube bracket 130 may be installed at a convenient location in the engine compartment or other convenient location on the automobile. For instance, drain tube mount bracket 130 may be installed inside the engine compartment in a location where there is easy access for draining the used engine oil. FIG. 3 is an illustration of installation of drain tube mount bracket 130.

As illustrated, drain tube bracket 130 may be mounted to the fender-well or firewall using a plurality of self tapping screws 180. After mounting the bracket, the other end 104 of drain tube 110 may be passed from the drain plug location to the new drain tube bracket 130 location. Subsequently, drain tube 110 may be clipped on to bracket 130 via sleeve 106, as illustrated in FIG. 4. Finally, oil drain cap 120 may be installed in place at end 104 of drain tube 110 to act as the new drain plug/cover.

With this relocation of the oil drain plug, engine oil change may be accomplished with the procedure illustrated in FIG. 5. As illustrated, one end of a first piece of tubing 150(1), which could be made of nylon or other appropriate material, may be inserted into or over section 104 of drain tube 110, and the second end of the first piece of tubing 150(1) inserted into or over section 501 of pump 140.

In addition, one end of a second piece of tubing 150(2), which could be made of nylon or other appropriate material, may be inserted into or over section 502 of pump 140 and the second end of the second piece of tubing 150(2) placed over drain pan 510. The pump may subsequently be plugged into a power outlet, e.g. a cigarette outlet, and then switched on. When the pump is switched on, used oil flows from the engine block 240, through banjo bolt 170, through drain tube 110, through tubing 150(1), and finally through tubing 150(2) to drain pan 510.

After the oil stops flowing into drain pan 510, the pump 140 may be stopped, disconnected, and stowed. The used oil may subsequently be appropriately disposed. Thus, changing engine oil will no longer require crawling under the engine with its incident hazards. The operator simply plugs in the pump at the relocated drain plug (i.e., at 104), plugs the pump power connector into a cigarette lighter socket, attaches the nylon tubing to the oil drain tube, turns the pump on, and the oil is removed by the pump action. Additionally, a storage connector may be included for the nylon tubing so that both ends plug into each other, eliminating any residual spillage when stowed away after use.

As described, this aspect of the invention has particular utility in changing the location at which oil may be drained from an engine. While the invention has particular utility with respect to engines of automobiles, the invention has utility with respect to engines used in other applications, such as trucks, busses, motorcycles, trains, planes and other vehicles, as well as in non-vehicle type applications, such as engines used to power fixed or movable equipment. The invention may also be utilized to change the location at which other types of fluid may be removed from an engine or associated components, such as hydraulic transmission fluid or the like.

Various alternate embodiments of the invention are contemplated. In one embodiment, the system need not include a pump, and may include only a single oil drain tube 110. The second end of that tube 110 may selectively accept a cap for closing the tube 110. For example, in the case of an automobile, oil is stored in an oil sump or pan which is supported by the vehicle above ground level. A user of the system may simply move the second end of the drain tube 110 to a position below the oil pan, whereby gravity will induce a flow of oil through the tube, thus removing the oil from the pan.

The oil drain tube 110 may also be connected to the engine oil drain in other manners. In one embodiment, the first end of the tube 110 may included a threaded fitting which allows the oil drain tube 110 to be directly threaded into engagement with the drain hole 260.

The pump 140 may be other than electrically powered. For example, the pump may be a mechanically driven pump, such as a foot compression pump or a hand crank pump.

The drain tube 110 may also be mounted to the vehicle in other ways than with use of the bracket 130 illustrated. For example, a simple clamp may be attached to portion of the engine, that clamp configured to selectively engage the drain tube. The clamp might be, for example, a spring-clip which may be opened to accept the tube, and then be closed to engage the tube.

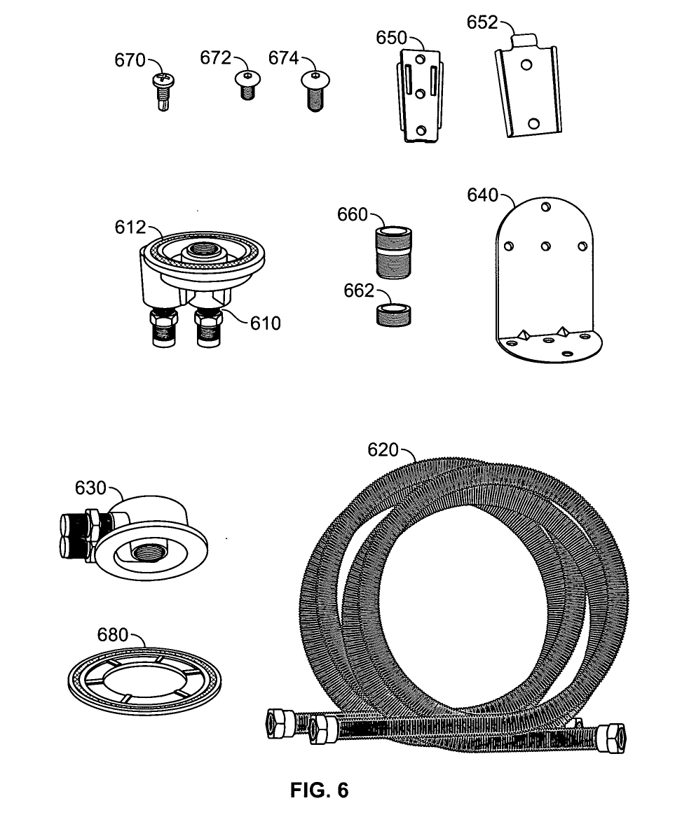

In one or more embodiments, the oil filter may also be relocated for ease of servicing. The components of one embodiment of a quick change oil filter relocation system are illustrated in FIG. 6.

As illustrated, in a preferred embodiment, the filter relocation system comprises a lower filter adapter 610; two filter relocation tubes 620; an upper filter adapter 630; “L” bracket 640 and/or removable bracket 650; and several mounting screws (e.g. 670, 672, and 674) and sleeves (e.g. 660 and 662). FIGS. 7 through 14 illustrate the process of relocating the oil filter to a more convenient location in the engine compartment.

As one aspect of the invention, the lower filter adapter 610 is configured to attach to an engine or associated structure at the location of the oil filter. Most commonly, oil filter are configured to thread onto a mount or sleeve which extends from the engine. As illustrated in FIG. 7, the initial step involves determining the configuration of this filter sleeve 660. This may be done with an original oil filter which is removed from the engine block or a replacement filter. In one embodiment, a plurality of sleeves 660 of differing types (such as by differing in diameter and/or thread spacing). Through a process of elimination using the sleeves 660, the configuration of the actual sleeve on the engine may be determined.

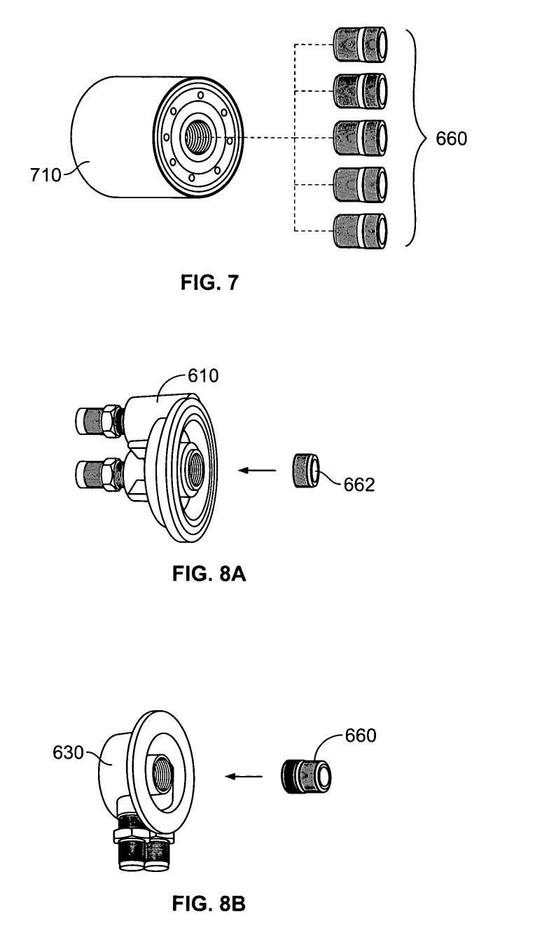

For each embodiment of filter sleeve 660, there is a corresponding adapter sleeve 662. Thus, once the filter sleeve is selected, a corresponding adapter sleeve is also automatically selected. The adapter sleeve 660 is then coupled with (i.e. screwed into) lower filter adapter 610, as illustrated in FIG. 8A. In addition, filter sleeve 660 is coupled with upper filter adapter 630, as illustrated in FIG. 8B.

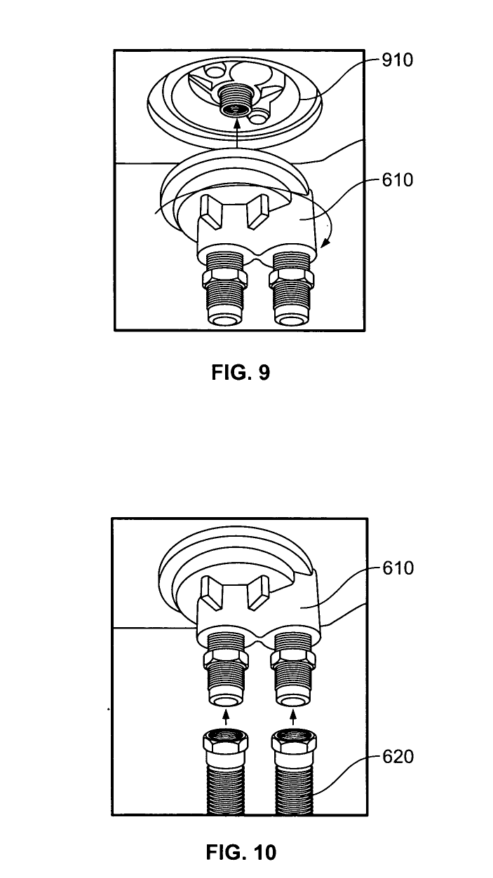

Subsequently, as illustrated in FIG. 9, lower filter adapter 610 (with o-ring 672) may be coupled into the original filter location 910. Original filter location 910 is the slot wherefrom the original oil filter was removed. In some instances, coupling of lower filter adapter 610 to filter location 910 may require adapter ring 680. In such cases, the adapter ring 680 is installed before the lower filter adapter 610 is installed in place of the original filter.

After installation of the lower filter adapter 610 into the original filter location 910, filter relocation tubes 620 are installed as illustrated in FIG. 10. Each of filter relocation tubes 620 may be configured to thread in a different direction or with a different color to assure proper routing of the tubes. After coupling to adapter 610, relocation tubes are routed through the engine compartment to a location, e.g. near the hood, where the oil filter will now be mounted for quick access. When the oil filter needs to be removed next time the oil is changed, the kit has a quick disconnect and re-connect of the oil filter adapter bracket that allows the oil filter to be held at such an angle as to drain it completely before removal, eliminating spillage.

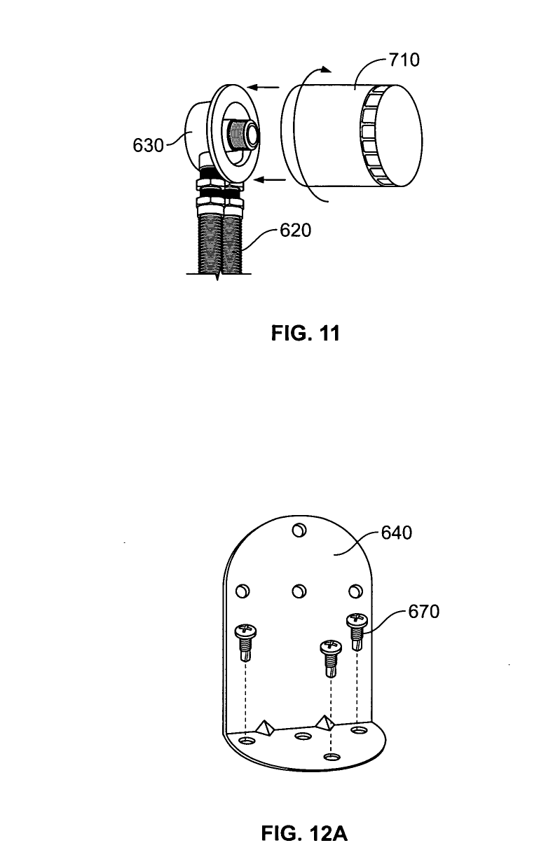

Subsequently, upper filter adapter 630 may be coupled with the free end of relocation tubes 620 as illustrated in FIG. 11. Oil filter 710 may then be coupled into place with the upper filter adapter 630 which may then be mounted at an appropriate location in the engine compartment.

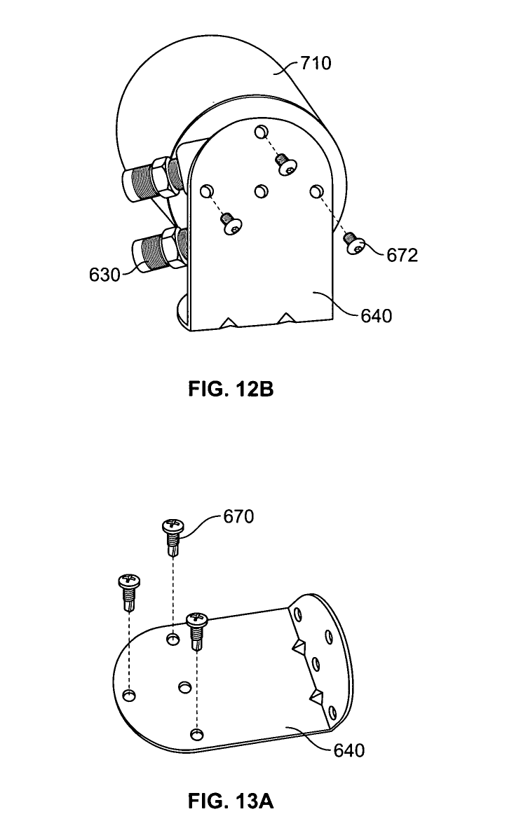

FIGS. 12, 13, and 14 are illustrations of a few mounting options for the upper filter adapter 630 at the new filter location. In FIG. 12A, the short arm of the “T” bracket is mounted at the new location (e.g. fender-well or firewall) using self tapping screws 670. Subsequently, the upper filter adapter 630 and filter 710 assembly is coupled to the long arm of the “T” bracket using a plurality of pan head screws (e.g. short pan head screws 672), as illustrated in FIG. 12B.

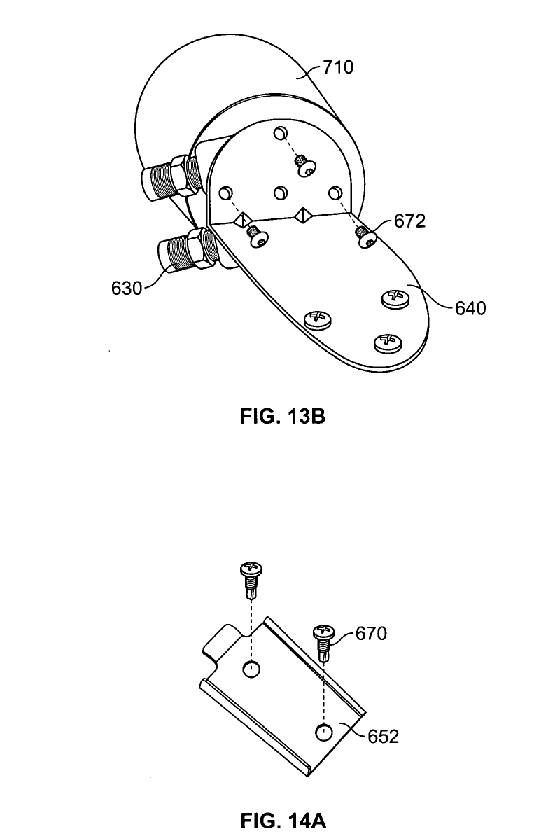

In FIG. 13A, the long arm of the “T” bracket is mounted at the new location (e.g. fender-well or firewall) using self tapping screws 670. Subsequently, the upper filter adapter 630 and filter 710 assembly is coupled to the short arm of the “T” bracket using a plurality of pan head screws (e.g. short pan head screws 672), as illustrated in FIG. 13B.

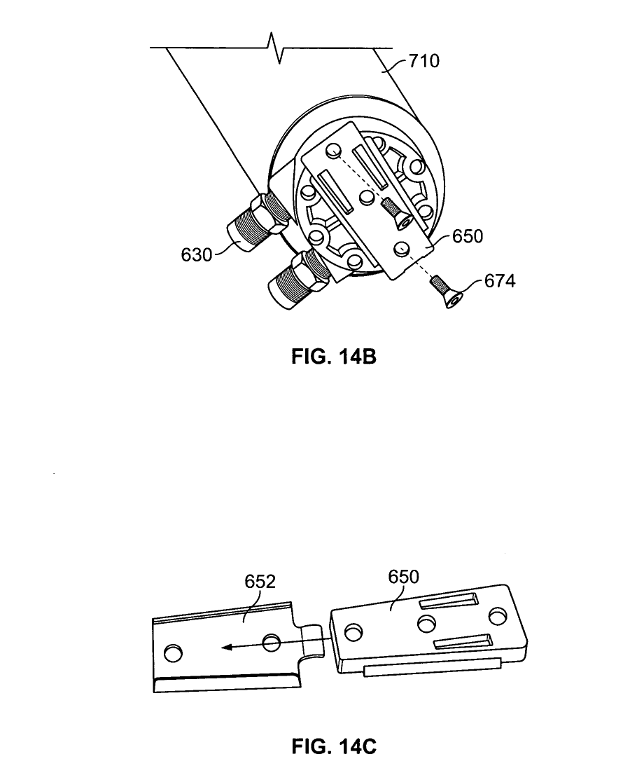

In FIG. 14A, removable bracket base 652 is mounted at the new location. For instance, the removable bracket base 652 may be mounted at the new location by direct installation on the fender-well or firewall), or mounted on an “T” bracket which may have be mounted as illustrated in FIG. 12A.

Subsequently, as illustrated in FIG. 14B, removable bracket 650 may be coupled to the upper filter adapter 630 using a plurality of pan-head screws (e.g. long pan-head screws 674). FIG. 14C is an illustration of the mating of removable bracket 650 and its base 652.

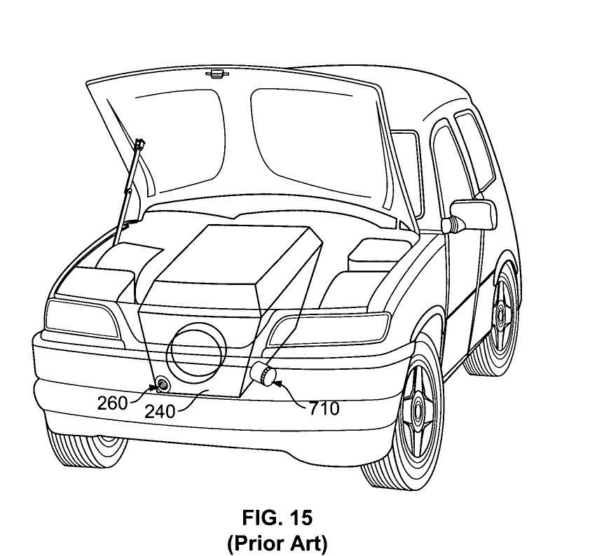

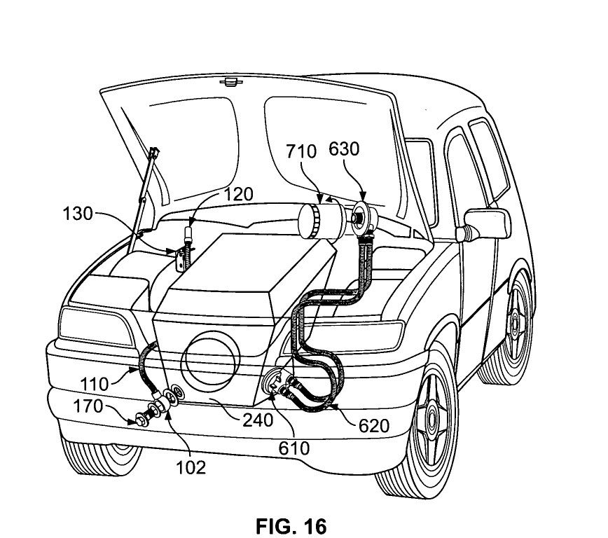

Finally, after installation of the quick oil change system and the filter relocation system of an embodiment of the present invention, the drain plug and oil filter locations of the prior art, illustrated in FIG. 15, are reconfigured as illustrated in FIG. 16. As illustrated, the drain plug location is moved from location 260 to the top of the engine compartment wherein it is covered by the cap 120. In addition, the oil filter 710 is moved from its original inaccessible location (illustrated in FIG. 15) to the top of the engine (illustrated in FIG. 16).

Once again, this aspect of the invention may be applied to various engines, including engines used to power other types of vehicles other than automobiles.

While two relocation tubes 620 are illustrated, it will be appreciated that a single tube defining two passages may be utilized.

Further, once again, the relocated oil filter 710 may be relocated to a variety of locations, and may be supported or mounted in a variety of ways other than the embodiment described above.

The relocation tubes 620 may be coupled to the lower filter adapter 610 in a variety of fashions other than that described. For example, the tubes 620 could be connected with quick-disconnect connectors, permitting quick replacement of the tubes 620.

Thus, a universal quick oil change system has been described. Particular embodiments described herein are illustrative only and should not limit the present invention thereby. The invention is defined by the claims and their full scope of equivalents.

The claimed invention is:

1. A universal oil change apparatus comprising:
a drain tube having a first end and a second end, said first end of said drain tube couplable to an engine oil drain hole of an automobile;
a mounting bracket configured for securing said second end of said drain tube;
an oil drain cap removably couplable to said second end of said drain tube for closing said second end of said drain tube; and
a pump couplable to said second end of said drain tube for extracting said engine oil from said automobile.

2. The apparatus of claim 1, wherein said first end of said drain tube is configured as a banjo head.

3. The apparatus of claim 1, wherein said mounting bracket is mountable in an accessible location in said automobile's engine compartment.

4. The apparatus of claim 3, wherein said accessible location is a fender-well in said automobile's engine compartment.

5. The apparatus of claim 3, wherein said accessible location is a firewall in said automobile's engine compartment.

6. The apparatus of claim 1, wherein said pump is operable with power available from said automobile's cigarette lighter.

7. The apparatus of claim 1, further comprising:
an oil filter relocation system.

8. The apparatus of claim 7, wherein said oil filter relocation system comprises:
a lower filter adapter module mountable in an original oil filter location of said automobile, said lower filter adapter module having a first nipple and a second nipple;
a first relocation tube couplable at one end to said first nipple of said lower filter adapter module;
a second relocation tube couplable at one end to said second nipple of said lower filter adapter module;
an upper filter adapter module mountable in an accessible filter location in said automobile's engine compartment, said upper filter adapter module having a third nipple and a fourth nipple and configured to hold a replacement oil filter for said automobile,
wherein a second end of said first relocation tube is couplable to said third nipple, and a second end of said second relocation tube is couplable to said fourth nipple; and
a mounting bracket configured for securing said upper filter adapter in said accessible filter location in said automobile's engine compartment.

9. The apparatus of claim 8, wherein said accessible filter location in said automobile's engine compartment is a fender-well.

10. The apparatus of claim 8, wherein said accessible filter location in said automobile's engine compartment is a firewall.

11. A method for configuring an automobile for a universal quick oil change capability comprising:
coupling a drain tube having a first end and a second end to an engine oil drain hole of an automobile, wherein said first end of said drain tube is coupled to said engine oil drain hole of said automobile's engine block to provide pass-through of said engine oil from said engine block to said second end of said drain tube;
installing a mounting bracket in a suitable location in said automobile's engine compartment, wherein said mounting bracket is configured for securing said second end of said drain tube;
installing a removable oil drain cap on said second end of said drain tube for closing said second end of said drain tube; and
providing a pump couplable to said second end of said drain tube when necessary to extract said engine oil from said engine block.

12. The method of claim 11, wherein said suitable location in said automobile's engine compartment is a fender-well.

13. The method of claim 11, wherein said suitable location in said automobile's engine compartment is a firewall.

14. The method of claim 11, further comprising:
installing an oil filter relocation system.

15. The method of claim 14, wherein said installing said oil filter relocation system comprises:
mounting a lower filter adapter module in an original oil filter location of said automobile, said lower filter adapter module having a first nipple and a second nipple;
coupling a first relocation tube at one end to said first nipple of said lower filter adapter module;
coupling a second relocation tube at one end to said second nipple of said lower filter adapter module;
mounting an upper filter adapter module in an accessible filter location in said automobile's engine compartment, said upper filter adapter module having a third nipple, a fourth nipple, and configured to hold a replacement oil filter for said automobile, wherein a second end of said first relocation tube is couplable to said third nipple, and a second end of said second relocation tube is couplable to said fourth nipple; and
installing a mounting bracket configured for securing said upper filter adapter module in said accessible filter location in said automobile's engine compartment.

16. The method of claim 15, wherein said accessible filter location in said automobile's engine compartment is a fender-well.

17. The method of claim 15, wherein said accessible filter location in said automobile's engine compartment is a firewall.
